(19) United States
(12) Patent Application Publication
(10) Pub. No.: US 2009/0085848 A1
(43) Pub. Date: Apr. 2, 2009

(54) Liquid crystal display with color sensor on substrate

(75) Inventors: Shun-Ming Huang, Shenzhen (CN); An Shih, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/286,382

(22) Filed: Sep. 29, 2008

(30) Foreign Application Priority Data
Sep. 28, 2007 (CN) 200710123703.3

(51) Int. Cl. G09G 3/36

(52) U.S. Cl. 345/88

(57) ABSTRACT

An exemplary liquid crystal display includes a substrate, a light source, and a color feedback system. The light source includes light emitting diodes. The color feedback system includes either one color sensor or plural color sensors. In one example, a single color sensor is disposed on the substrate and samples the light at the substrate. The color feedback system adjusts the brightness of the light emitting diodes according to the sampling signals of the color sensor.

### FIELD OF THE INVENTION

The present invention relates to liquid crystal displays (LCDs), and particularly to an LCD with a color sensor on a substrate.

### GENERAL BACKGROUND

In various display technologies, a required color can be obtained by mixing primary colors. For example, white can be obtained by mixing red (R), green (G), and blue (B) in an optical mixing cavity of a display device. The mixing cavity has many applications. For example, the mixing cavity combined with a suitable light guide plate can be used as a backlight for an LCD. In this case, it is very important to mix the primary colors thoroughly. Thus, a color feedback system is needed in the LCD.

FIG. 8 is a schematic view of a conventional LCD. The LCD 10 includes a mixing cavity 11 and a color feedback system 12. The color feedback system 12 includes a color sensor 121, an analog to digital (AID) converter 122, a color controller 123, and a light emitting diode (LED) driver 124. The mixing cavity 11 includes a plurality of red LEDs (R), green LEDs (G), and blue LEDs (B).

The red LEDs, the green LEDs, and the blue LEDs emit red light, green light, and blue light, respectively. The red light, the green light, and the blue light are sufficiently mixed into white light in the mixing cavity 11. The color sensor 121 samples the white light and then outputs three individual analog signals V_{R}, V_{G}, V_{B} to the A/D converter 122. The analog signal V_{R} represents a red component of the white light, the analog signal V_{G} represents a green component of the white light, and the analog signal V_{B} represents a blue component of the white light. The A/D converter 122 converts the three individual analog signals V_{R}, V_{G}, V_{B} into three individual digital signals R_{MEAS}, G_{MEAS}, B_{MEAS}, respectively. The color controller 123 receives the three individual digital signals R_{MEAS}, G_{MEAS}, B_{MEAS}, and outputs three individual control signals R_{CON}, G_{CON}, B_{CON}, correspondingly. The LED driver 124 receives the three control signals R_{CON}, G_{CON}, B_{CON}, and outputs three individual drive voltages R_{DRV}, G_{DRV}, B_{DRV}, correspondingly. The drive voltage R_{DRV} is used to control the brightness of the red LEDs, the drive voltage G_{DRV} is used to control the brightness of the green LEDs, and the drive voltage B_{DRV} is used to control the brightness of the blue LEDs.

In fact, the analog signals V_{R}, V_{G}, V_{B} outputted from the color sensor 121 vary with the ambient temperature of the color sensor 121, as shown in FIG. 9. In FIG. 9, the left graph illustrates a functional relation between the analog signal V_{R} and an intensity of the red component of the white light I_{R} when the ambient temperature of the color sensor 121 is 25° C., and the right graph illustrates a functional relation between the analog signal V_{R} and the intensity I_{R} when the ambient temperature of the color sensor 121 is 125° C. As seen, the analog signals V_{R} are different at any same point of intensity I_{R} when the ambient temperature varies. The above kind of functional relation also exists between the analog signal V_{G} and an intensity I_{G} of the green component of the white light, and between the analog signal V_{B} and an intensity I_{B} of the blue component of the white light.

In practice, the temperature of the mixing cavity 11 tends to increase with the continuous operation of the LCD 10 over a period of time. The main reason for this is the heat that is generated by the LEDs of the mixing cavity 11. Typically, the ambient temperature of the color sensor 121 correspondingly increases. The analog signals outputted from the color sensor 121 vary when the ambient temperature increases. That is, the accuracy of the color sensor 121 declines, and the accuracy of the color feedback system 12 declines correspondingly. Because of the above problem, the display quality of the LCD 10 is liable to be adversely affected.

### SUMMARY

In accordance with one embodiment of the present invention, a liquid crystal display includes a transparent substrate, a light source, and a color feedback system. The light source includes a plurality of light emitting diodes. The color feedback system includes at least one color sensor. The substrate is capable of transmitting light originating from the light source, the at least one color sensor is disposed on the substrate and is configured to sample the light at the substrate and generate corresponding sampling signals, and the color feedback system is configured to adjust the brightness of the light emitting diodes according to the sampling signals of the at least one color sensor.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a side, cross-sectional view of an LCD according to a first embodiment of the present invention, the LCD including a light source and a color feedback system.

FIG. 2 is a plan view of the light source of FIG. 1.

FIG. 3 is a block diagram of the color feedback system of FIG. 1, also showing LEDs of the light source.

FIG. 4 is a plan view of an LCD according to a second embodiment of the present invention, the LCD including a light source and a color feedback system.

FIG. 5 is a block diagram of the color feedback system of FIG. 4, also showing LEDs of the light source.

FIG. 6 is a plan view of an LCD according to a third embodiment of the present invention.

FIG. 7 is a plan view of an LCD according to a fourth embodiment of the present invention.

FIG. 8 is a block diagram of a conventional LCD, the LCD including a color sensor.

FIG. 9 illustrates a functional relation between an analog signal V_{R} and an intensity of a red component of white light I_{R} when the ambient temperature of the color sensor of FIG. 8 is respectively 25° C. and 125° C.

### DETAILED DESCRIPTION OF EMBODIMENTS

Reference will now be made to the drawings to describe various embodiments of the present invention in detail.

FIG. 1 is a schematic, side cross-sectional view of an LCD according to a first embodiment of the present invention. The LCD 200 includes an LCD panel 20, a backlight module 28, and a color feedback system 30 (see FIG. 3). The backlight module 28 is disposed at a rear side of the LCD panel 20. The LCD panel 20 includes a color filter substrate (CF substrate) 21, a thin film transistor substrate (TFT substrate) 23, and a liquid crystal layer 22 interposed therebetween. The TFT substrate 23 is a transparent substrate. The LCD panel 20 also includes a flexible printed circuit (FPC) 233. The color feedback system 30 includes a color sensor 230 connected to an indium tin oxide (ITO) circuit (not shown) on the TFT substrate 23 via anisotropic conductive films 231. One terminal of the FPC 233 is connected to the ITO circuit on the TFT substrate 23 via one or more anisotropic conductive films 231. The other terminal of the FPC 233 is connected to a circuit board (not shown) of the LCD 200. The backlight module 28 includes a diffusion sheet 24, a light guide plate 25, a reflective sheet 26, and a light source 27. The light guide plate 25 includes a top light emitting surface 252, a bottom surface 253, and a light incident surface 251 adjoining the light emitting surface 252 and the bottom surface 253. The light source 27 is located adjacent to the light incident surface 251. The diffusion sheet 24 is disposed on the light emitting surface 252, and the reflective sheet 26 is disposed on the bottom surface 253.

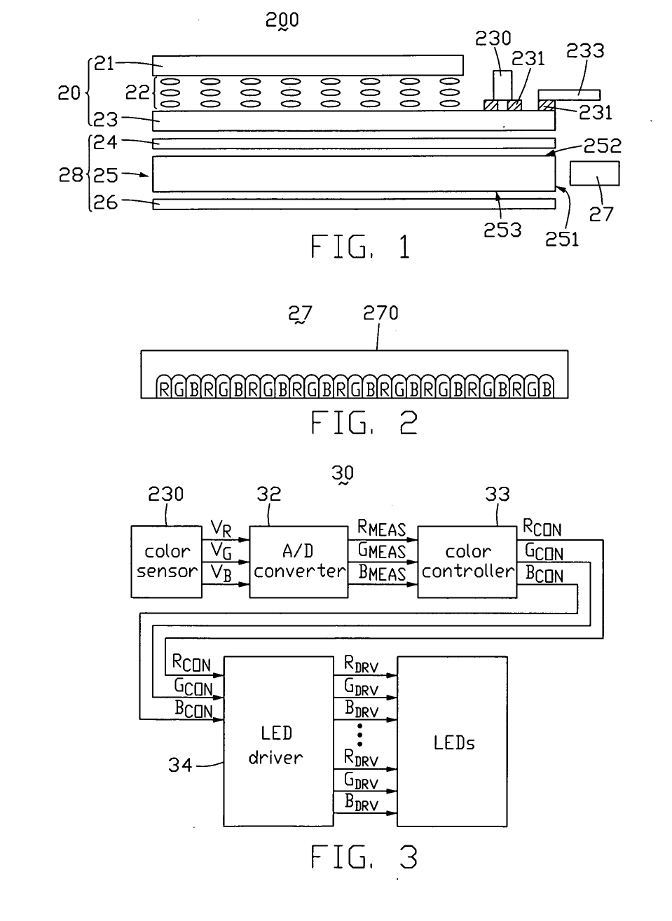

Referring also to FIG. 2, the light source 27 includes a mixing cavity 270 and a plurality of red LEDs (R), green LEDs (G), and blue LEDs (B). The red LEDs, the green LEDs, and the blue LEDs emit red light, green light, and blue light, respectively. The red light, the green light, and the blue light are sufficiently mixed into white light in the mixing cavity 270. The white light enters the light guide plate 25 via the light incident surface 251. Part of the white light emits from the light emitting surface 252 directly, and the other part of the white light is reflected by the reflective sheet 26 before emitting from the light emitting surface 252. As a result, almost all the light from the light source 27 passes through the light guide plate 25, and is diffused by the diffusion sheet 24 before entering the TFT substrate 23.

FIG. 3 is a block diagram of the color feedback system 30, also showing a block for the LEDs of the light source 27. The color feedback system 30 includes the color sensor 230, an A/D converter 32, a color controller 33, and an LED driver 34. The A/D converter 32, the color controller 33, and the LED driver 34 are disposed on the circuit board of the LCD device 200.

The color sensor 230 samples the white light and then outputs three individual analog signals V_{R}, V_{G}, V_{B} to the A/D converter 32. The analog signal V_{R} represents a red component of the white light, the analog signal V_{G} represents a green component of the white light, and the analog signal V_{B} represents a blue component of the white light. The A/D converter 32 converts the three individual analog signals V_{R}, V_{G}, V_{B} into three individual digital signals R_{MEAS}, G_{MEAS}, B_{MEAS}, respectively. The color controller 33 receives the three individual digital signals R_{MEAS}, G_{MEAS}, B_{MEAS}, and outputs three individual control signals R_{CON}, G_{CON}, B_{CON}, correspondingly. The LED driver 34 receives the three control signals R_{CON}, G_{CON}, B_{CON}, and outputs three individual drive voltages R_{DRV}, G_{DRV}, B_{DRV}, correspondingly. The drive voltage R_{DRV} is used to control the brightness of the red LEDs, the drive voltage G_{DRV} is used to control the brightness of the green LEDs, and the drive voltage B_{DRV} is used to control the brightness of the blue LEDs.

Because the light source 27 does not contact the TFT substrate 23, the ambient temperature of the light source 27 has little influence on the TFT substrate 23. Correspondingly, the light source 27 has little or no effect on the ambient temperature of the color sensor 230. Accordingly, the accuracy of the color sensor 230 can be improved. Thus, the accuracy of the color feedback system 30 is also improved. Furthermore, the location of the color sensor 230 as illustrated in FIG. 1 enables the LCD 200 to have a compact configuration.

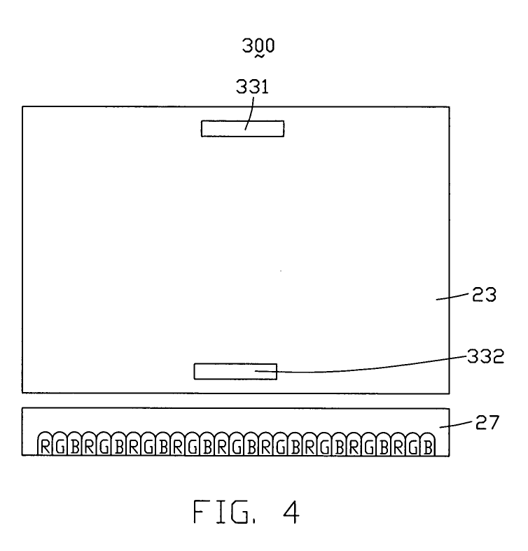

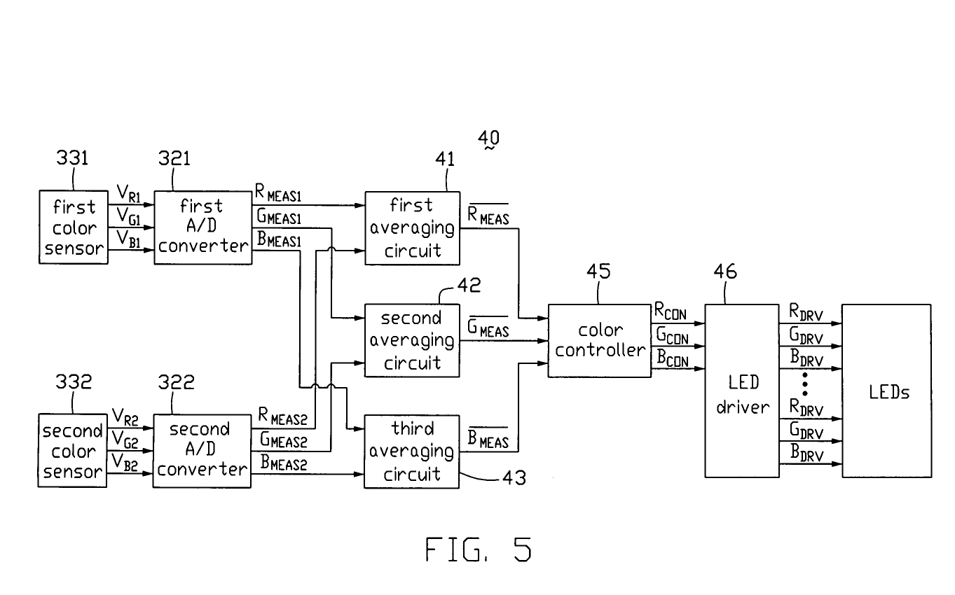

FIG. 4 is a plan view of an LCD 300 according to a second embodiment of the present invention. The LCD 300 is generally similar to the LCD 200. However, a TFT substrate 23 of the LCD 300 includes a first color sensor 331 and a second color sensor 332. The first color sensor 331 and the second color sensor 332 are disposed on opposite edge portions of a major surface of the TFT substrate 23. For example, the second color sensor 332 is adjacent to the light source 27, and the first color sensor 331 is far from the light source 27.

FIG. 5 is a block diagram of a color feedback system of the LCD 300, also showing a block for the LEDs of the light source 27. The color feedback system 40 includes the first color sensor 331, the second color sensor 332, a first A/D converter 321, a second A/D converter 322, a first averaging circuit 41, a second averaging circuit 42, a third averaging circuit 43, a color controller 45, and an LED driver 46. The first color sensor 331 samples the white light emitting from the TFT substrate 23, and outputs individual analog signals V_{R1}, V_{G1}, V_{B1}. The second color sensor 332 samples the white light emitting from the TFT substrate 23, and outputs individual analog signals V_{R2}, V_{G2}, V_{B2}. The first A/D converter 321 receives the analog signals V_{R1}, V_{G1}, V_{B1} and outputs digital signals R_{MEAS1}, G_{MEAS1}, B_{MEAS1}; and the second A/D converter 322 receives the analog signals V_{R2}, V_{G2}, V_{B2} and outputs digital signals R_{MEAS2}, G_{MEAS2}, B_{MEAS2}. The first averaging circuit 41 averages the digital signals R_{MEAS1}, R_{MEAS2}, and outputs the mean value [symbol] The second averaging circuit 42 averages the digital signals G_{MEAS1}, G_{MEAS2}, and outputs the mean value [symbol] The third averaging circuit 43 averages the digital signals B_{MEAS1}, B_{MEAS2}, and outputs the mean value [symbol] The color controller 45 receives the mean values [symbol] and correspondingly outputs control signals R_{CON}, G_{CON}, B_{CON}. The LED driver 46 receives the control signals R_{CON}, G_{CON}, B_{CON}, and correspondingly outputs drive voltages R_{DRV}, G_{DRV}, B_{DRV}. The drive voltage R_{DRV} is used to control the brightness of the red LEDs, the drive voltage G_{DRV} is used to control the brightness of the green LEDs, and the drive voltage B_{DRV} is used to control the brightness of the blue LEDs.

The color feedback system 40 samples the white light at different positions and averages the sample signals to control the brightness of the light source 27. Therefore, the accuracy of the color feedback system 40 is further improved.

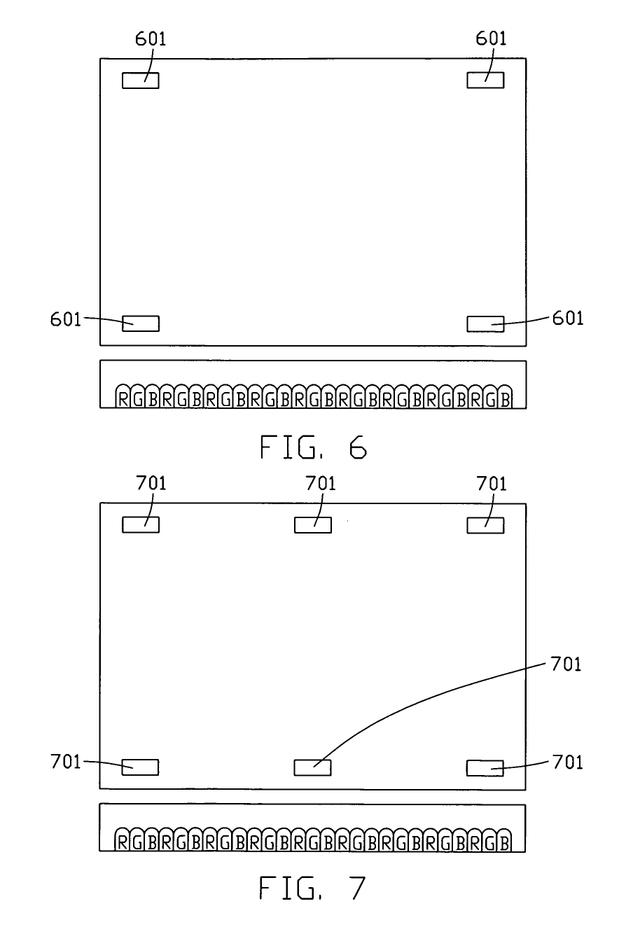

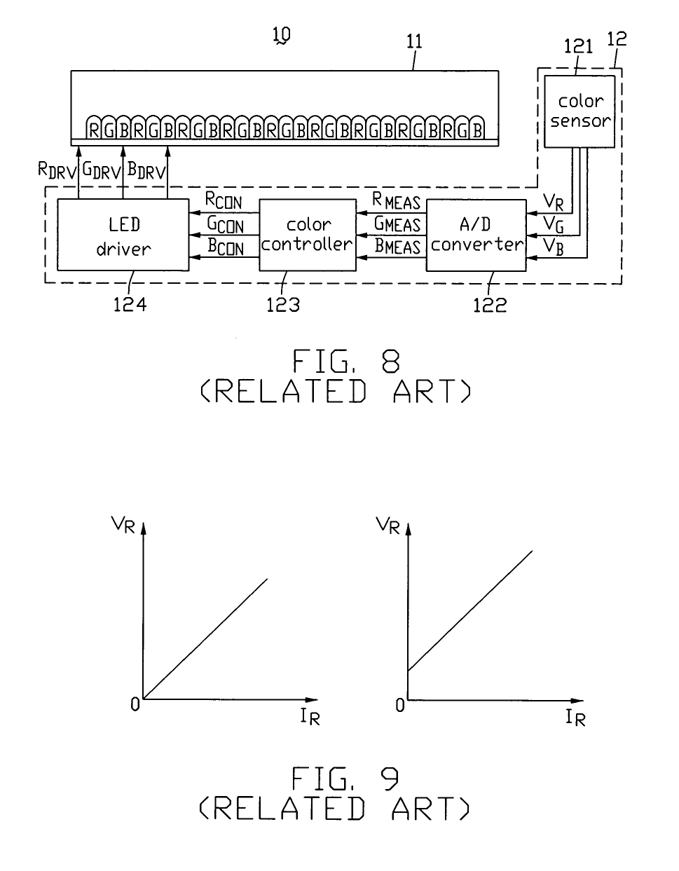

Referring to FIG. 6, in a third embodiment, the color feedback system includes four color sensors 601. The four color sensors 601 can be disposed on four corner areas of the major surface of the TFT substrate 23. In other embodiments, the color feedback system can include N color sensors 701 (where N is a natural number). Referring to FIG. 7, in an exemplary fourth embodiment, N is equal to six. In further or alternative embodiments, the color sensor(s) of any of the above embodiments can be disposed on the CF substrate 21. In such cases, each color sensor may be disposed on a selected one of an upper major surface of the CF substrate 21 and a lower major surface of the CF substrate 21.

It is to be further understood that even though numerous characteristics and advantages of various embodiments have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. A liquid crystal display, comprising:
a transparent substrate;
a light source comprising a plurality of light emitting diodes; and
a color feedback system comprising at least one color sensor;
wherein the substrate is capable of transmitting light originating from the light source, the at least one color sensor is disposed on the substrate and is configured to sample the light at the substrate and generate corresponding sampling signals, and the color feedback system is configured to adjust the brightness of the light emitting diodes according to the sampling signals of the at least one color sensor.

2. The liquid crystal display of claim 1, wherein the substrate is a thin film transistor substrate.

3. The liquid crystal display of claim 2, wherein the color feedback system comprises an analog to digital converter, a color controller, and a light emitting diode driver, the analog to digital converter is configured to convert the sampling signals to digital signals, the color controller is configured to output control signals according to the digital signals, and the light emitting diode driver is configured to adjust the brightness of the light emitting diodes according to the control signals.

4. The liquid crystal display of claim 3, wherein the thin film transistor substrate comprises an indium tin oxide circuit, and the at least one color sensor is connected to the indium tin oxide circuit.

5. The liquid crystal display of claim 4, further comprising a circuit board and a flexible printed circuit, wherein one terminal of the flexible printed circuit is connected to the indium tin oxide circuit, and the other terminal of the flexible printed circuit is connected to the circuit board.

6. The liquid crystal display of claim 5, wherein the analog to digital converter, the color controller, and the light emitting diode driver are disposed on the circuit board.

7. The liquid crystal display of claim 1, wherein the substrate is a color filter substrate.

8. The liquid crystal display of claim 1, further comprising a light guide plate, the light guide plate comprising a top light emitting surface, a bottom surface, and a light incident surface adjacent to the light emitting surface and the bottom surface, the light source being located adjacent to the light incident surface of the light guide plate.

9. The liquid crystal display as claimed in claim 1, wherein the at least one color sensor comprises a first color sensor and a second color sensor.

10. The liquid crystal display as claimed in claim 9, wherein the substrate is a thin film transistor substrate.

11. The liquid crystal display as claimed in claim 10, wherein the first color sensor and the second color sensor are disposed on opposite edges of the substrate.

12. The liquid crystal display as claimed in claim 11, wherein the color feedback system comprises a first analog to digital converter, a second analog to digital converter, a first averaging circuit, a second averaging circuit, a third averaging circuit, a color controller, and a light emitting diode driver, the first analog to digital converter is configured to respectively output three digital signals representing a red component, a green component and a blue component of the light emitting from the substrate according to the sampling signals of the first color sensor; the second analog to digital converter is configured to respectively output digital signals representing a red component, a green component and a blue component of the light emitting from the substrate according to the sampling signals of the second color sensor; the first averaging circuit is configured to average the two digital signals representing the red components, the second averaging circuit is configured to average the two digital signals representing the green components, and the third averaging circuit is configured to average the two digital signals representing the blue components; and the color controller is configured to receive outputs of the first averaging circuit, the second averaging circuit, and the third averaging circuit, and output control signals according to the outputs of the three averaging circuits to adjust the brightness of the light emitting diodes.

13. The liquid crystal display of claim 12, further comprising a circuit board and a flexible printed circuit, the thin film transistor substrate comprising an indium tin oxide circuit, one terminal of the flexible printed circuit being connected to the indium tin oxide circuit of the thin film transistor substrate, the other terminal of the flexible printed circuit being connected to the circuit board.

14. The liquid crystal display of claim 13, wherein the analog to digital converter, the color controller, and the light emitting diode driver are disposed on the circuit board.

15. The liquid crystal display of claim 9, wherein the substrate is a color filter substrate.

16. The liquid crystal display as claimed in claim 1, wherein the at least one color sensor comprises four color sensors.

17. The liquid crystal display as claimed in claim 16, wherein the four color sensors are disposed on four corner areas of the substrate.

18. A liquid crystal display, comprising:
a light source comprising primary color light emitting elements, the light source configured to mix primary colors output by the primary color light emitting elements and thereby output mixed light;
a transparent substrate; and
a color feedback system comprising at least one color sensor;
wherein the substrate is capable of transmitting the light output from the light source, the at least one color sensor is provided on the substrate at a predetermined location away from the light source, the at least one color sensor is configured to sample the light at the substrate and generate corresponding sampling signals, and the color feedback system is configured to adjust the brightness of the primary color light emitting elements of the light source according to the sampling signals of the at least one color sensor.
